(19) United States
(12) Patent Application Publication
(10) Pub. No.: US 2016/0173320 A1
(43) Pub. Date: Jun. 16, 2016

(54) METHOD AND SYSTEM FOR AN ADAPTIVE SOFTWARE-DEFINED NETWORKING CONTROLLER (aSDNC)

(71) Applicant: ZTE (USA) INC., Richardson, TX (US)

(72) Inventor: Bhumip KHASNABISH, Lexington, MA (US)

(21) Appl. No.: 14/907,378

(22) PCT Filed: Jul. 28, 2014
(86) PCT No.: PCT/US2014/048434

§ 371 Date: Jan. 25, 2016

Related U.S. Application Data
(60) Provisional application No. 61/858,891, filed on Jul. 26, 2013.

(51) Int. Cl. H04L 12/24

(52) U.S. Cl. CPC H04L 41/046; H04L 41/20

(57) ABSTRACT

A method and system for the design, implementation, and operation of an adaptive software-defined networking controller (aSDNC) is described. Traditional SDN controllers support stateless control of forwarding/data-path elements (logical or physical) in order to provide quasi-seamless control/management of information flows. The proposed SDN controller can not only adapt to peripheral (both lower and upper) requirements of elements/devices, it can also help maintain the states of the flows and can scale well above any sets of management/operations requirements. Distributed management of states is achieved in an application/services specific fashion, and hence the complexity of the controller does not grow exponentially with the number of flows that are being managed by the controller. The details of the requirements and exemplary operations of the aSDNC are presented.

### FIELD OF THE INVENTION

The present invention describes a method and system for the design, implementation, and operation of an adaptive software-defined networking controller (aSDNC).

### BACKGROUND

Present day SDN controllers are static in nature. These controllers manage the flows based on pre-specified table-driven criteria and are not quick to change the flow management as dictated by the applications/services. This causes wastage of controller resources and inefficient management of the flows themselves.

### SUMMARY OF THE INVENTION

The SDN controller of the present nvention adapts to peripheral (both lower and upper) requirements of elements/devices, helps maintain the states of the flows, and can scale well above any sets of management/operations requirements. Distributed management of states is achieved in an application/services specific fashion, and hence the complexity of the controller does not grow exponentially with the number of flows that are being managed by the controller.

### BRIEF DESCRIPTION OF THE DRAWINGS

Reference will be made to the accompanying drawings, which are not necessarily drawn to scale, and wherein:

FIG. 1 shows a High-Level Schematic of an Adaptive Software-Defined Networking Controller (aSDNC) [adapted from Network Services Management Use Cases, http://www.dmtf.org/sites/default/files/standards/documents/DSP2034_1.0.0a.pdf, which is herein incorporated by reference in its entirety].

FIG. 2 shows an example of dynamic configuration management of an underlying entity from/through the aSDNC.

FIG. 3 shows an example of dynamic control of an underlying entity from/through the aSDNC.

FIG. 4 shows an example of dynamic management/maintenance (MetaData, Chaining, Grouping, etc.) of the underlying entities from/through the aSDNC.

Although specific teiins are employed herein, they are used in a generic and descriptive sense only and not for purposes of limitation.

### DESCRIPTION OF THE INVENTION

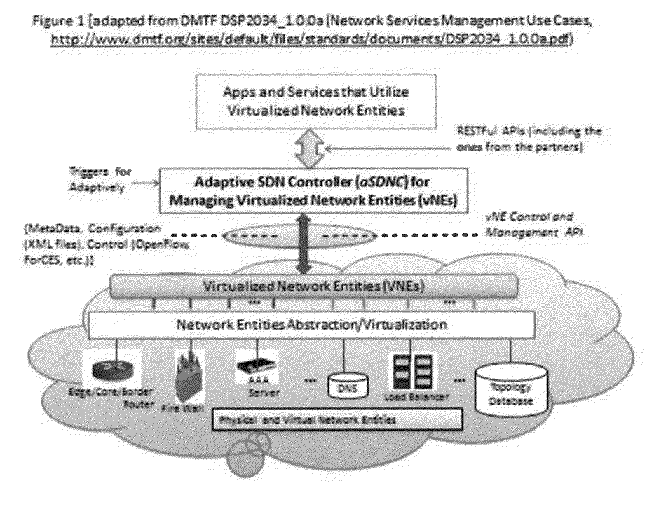

FIG. 1 shows a high-level schematic for abstraction of the network elements in order to expose them as the virtualized network entities (vNEs) for management by the aSDNC. As show in FIG. 1, the main components of virtualized networking include physical and virtual network elements/entities; vNEs; and application programming interface (API) for vNE control and management.

The network entities include various network components, such as routers, firewalls, AAA servers, DNS, load balancers, etc. These network components can be interconnected to support network services. Such network entities can be realized both as physical devices or virtual appliances. A common mechanism for virtualization of these generic network entities is generally required in order to achieve seamless interoperability. Once virtualization is done, the vNEs can be exposed through an API for control and management, and utilization by various applications and services.

The vNEs are the abstraction of the physical network entities and the network entities realized as virtual appliances. The vNEs can be combined flexibly to support virtualized networking services. These virtualized network entities can be exposed via a control and management API to the upper management layers. The control and management API can be used to create, assign, monitor, update, and release the vNEs, for example.

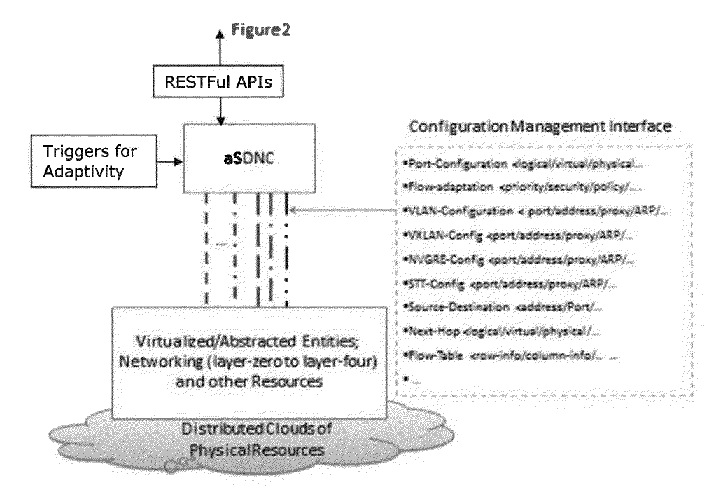

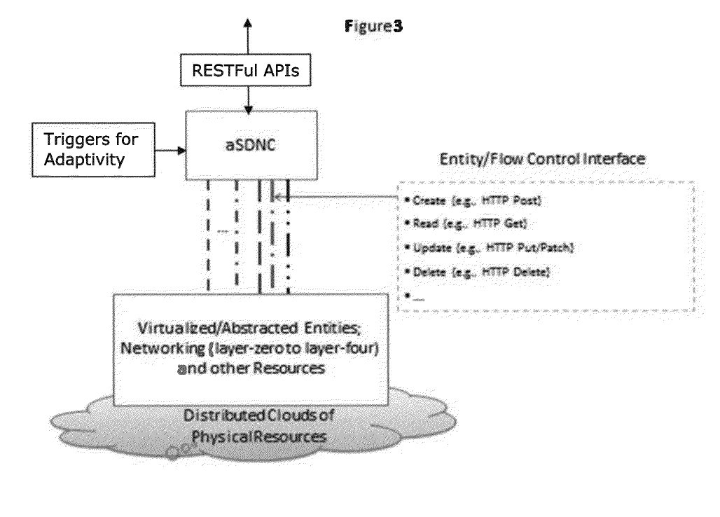

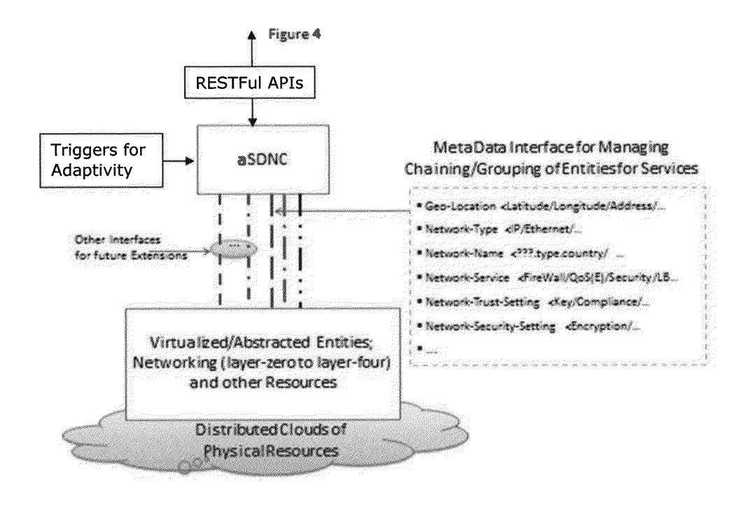

As noted above, and in accordance to certain embodiments of the present invention, FIG. 2 illustrates dynamic configuration management of an underlying entity from/through the aSDNC. FIG. 3 illustrates dynamic control of an underlying entity from/through the aSDNC. FIG. 4 illustrates dynamic management/maintenance (MetaData, Chaining, Grouping, etc.) of the underlying entities from/through the aSDNC. In FIGS. 2-4, the illustrated lines between the aSDNC and the virtualized/abstracted entities represent physical or virtual links that can support TCP/UDP over any and all variants of IP, MPLS, etc. over any variant of Ethernet over any wireline and wireless media.

Certain embodiments of the disclosed SDN controller described herein easily adapt to the requirements of the peripheral elements/devices. The peripheral elements/devices are either the lower (transport and infrastructure) layer elements or the upper (applications and services) layer elements, or both. The requirements range from the demands for specific service/experience quality to broader policy/security restrictions, and so on.

In addition, the design, implementation, and operation of certain embodiments of the disclosed SDN controller, on an on-demand basis, assist in maintaining the states of the flows and scale well above any sets of management/operations requirements. The states are managed in a distributed manner and in an application/services specific fashion. The complexity of state management is pushed to the application/service edge (that is, to the upper layer elements). This ensures that the complexity of the controller does not grow exponentially with the growth of the number of flows that are being managed.

The lower layer elements may include the following entities, for example:
Physical and virtual network port
Physical and virtual network link
Physical and virtual Topology (both Intra- and Inter-Domain ones)
Physical and virtual Topology Manager
Physical and virtual forwarding table
Physical and virtual routing engine

The upper layer elements may include the following entities, for example:
Physical and virtual value-added networked service entities (traffic steering, firewall, on-demand encryption and traffic/session monitorin ifurcaion, etc.)
Physical and virtual DNS
Physical and virtual DHCP sever
Physical and virtual load balancer
Physical and virtual AAA server
Spectrum (both licensed and public)

Agility and adaptivity in the SDN controller is beneficial, not only to manage the services effectively, but also to dynamically manage the logically centralized critical controller resources. This also helps to manage the infrastructure resources more effectively and intelligently, resulting in intelligent or smart management of the distributed workloads.

The resources could be from any layer of the ISO model, e.g., physical layer resources, link layer resources, transport layer resources, application/session layer resources. In general, the resources include any combination of physical/virtual of a few of the following entities:
Processing {Virtual, Physical, . . . }
Storage {Virtual, Physical, . . . }
Memory {Virtual, Physical, . . . }
Port {Physical, Logical., Virtual, . . . }
Access {Wireline, Wireless, Physical, Virtual, . . . }
DataPlane {Forwarding, Routing, . . . }
Connectivity {One-Domain, Multi-Domain, . . . }
Transport
Service {Host, Policy, Security, DHCP, DNS, VPN, . . . }
Spectrum (both licensed and pub;i)
Location

Embodiments of the present invention focus on an adaptive Software-defined Networking Controller (aSDNC). Through a set of open interfaces, the aSDNC configures, controls/manages, and maintains distributed physical and virtual resources with an objective to manage distributed workloads.

In certain embodiments, the Applications/Services communicates through RESTful APIs to the aSDNC based on the desired features/functions.

In certain embodiments, the aSDNC uses XML or JSON (through appropriate interpreter/converter) for configuring the underlying physical and virtual entities.

In certain embodiments, the aSDNC uses CSV (comma separated value) or other formatted information in metadata for managing service, feature/function, disaster, load, continuity, etc. via the underlying physical and virtual entities.

In certain embodiments, the aSDNC may use OpenFlow (from ONF) or ForCES (from IETF) for controlling the underlying physical and virtual entities.

A few use cases are as follows.
(A) Service Creation/Updating and Workload management in a Data Center: This is required for seamless management of multi-tenant workload without adding new physical infrastructure elements (servers, switches, routers, storage, etc.). This includes service chaining, and grouping of the virtual entities for dynamically creating/updating a services,
(B) Interconnection and capacity management among a set of geographically distributed Data Centers: This is required for seamless management of Inter-Data-Center Capacity without adding new physical infrastructure elements (links and nodes).
(C) Managing the capacity of software-defined core and functional network elements based on workload of each element: This is required for seamless management of capacity and capability for IMS and EPC elements without adding new physical infrastructure elements.
(D) Managing the capability of software-defined aggregation, segregation, steering, and gateway elements for specialized services: This is useful for mobile backhaul capacity and quality management without adding new physical infrastructure elements (links and nodes).
(E) Hosted virtual client and their features/function management: This is required for virtual client, agent and device (e.g., gaming, TV, educational, entertainment, etc.) management.
(F) Dynamically locating (logically moving an element to where it is needed) and right-sizing (delivering the desired capacity) the software-defined service elements like load-balancer, security devices, etc.: This is required for introducing new services without introducing new specialized networks, and thereby reducing CapEx and increasing the revenue margins through OpEx savings.

The foregoing descriptions illustrate and describe certain embodiments of the present invention. It is to be understood that the invention is capable of use in various other combinations, modifications, and environments; and is capable of changes or modifications within the scope of the inventive concept as expressed herein, commensurate with the above teachings and/or skill or knowledge in the relevant art.

The embodiments described hereinabove are further intended to enable others skilled in the art to utilize the invention in such, or other, embodiments; and with the various modifications required by particular applications or uses of the invention. Further, it should be understood that the methods and systems of the present invention are executed employing machines and apparatus including simple and complex computers.

Indeed, the architecture and methods described above can be stored on foin is of machine-readable media, including magnetic and optical disks. For example, the operations of the present invention could be stored on machine-readable media, such as magnetic disks or optical disks, which are accessible via a disk drive (or computer-readable medium drive). Alternatively, the logic to perform the operations as discussed above, could be implemented in additional computer and/or machine readable media, such as discrete hardware components as large-scale integrated circuits (LSI's), application-specific integrated circuits (ASIC's), firmware such as electrically erasable programmable read-only only memory (EEPROM's); and the like.

Adaptations of known systems and methods that are apparent to those skilled in the art based on the description of the invention contained herein are within the scope of the claims. Moreover, later-invented or later-developed equipment that carries out the methods and/or combination of elements set forth in the claims are within the scope of the invention. Accordingly, the description is not intended to limit the invention to the form or application disclosed herein.

What is claimed is:

1. An adaptive software-defined networking controller (aSDNC) comprising:
an SDN controller configured to adapt to peripheral requirements of one or more elements/devices, manage states of flows at upper layer elements, and scale above management/operation requirements.

2. The aSDNC of claim 1, wherein the SDN controller is further configured to manage the states of flows in an application/services-specific fashion.

3. The aSDNC of claim 2, wherein the SDN controller is further configured to manage the states of flows on an on-demand basis and in a distributed manner.

4. The aSDNC of claim 2, wherein the SDN controller comprises a configuration management interface.

5. The aSDNC of claim 2, wherein the SDN controller comprises an entity/flow control interface.

6. The aSDNC of claim 2, wherein the SDN controller comprises a metadata interface for managing chaining/grouping of entities for services.

7. The aSDNC of claim 2, wherein the applications/services communicate through RESTful APIs to the aSDNC based on desired features/function.

8. The aSDNC of claim 2, wherein the aSDNC uses XML or JSON for configuring the vNEs.

9. The aSDNC of claim 2, wherein the aSDNC uses comma separated value (CSV) for managing one or more virtualized network entities (vNEs).

10. The aSDNC of claim 2, wherein the aSDNC uses formatted information in metadata ‘for managing one or more vNEs.

11. The system of claim 2, wherein the aSDNC uses OpenFlow or ForCES for controlling underlying physical and virtual entities.

12. A system for virtualized networking comprising:
virtualized network entities (vNEs);
applications and services that utilize the vNEs;
an adaptive SDN controller (aSDNC) for managing the vNEs; and
a vNE control and management application programming interface (API).

13. The system of claim 12, wherein the aSDNC comprises a configuration management interface,

14. The system of claim 12, wherein the aSDNC comprises a entity/flow control interface.

15. The system of claim 12, wherein the aSDNC comprises a metadata interface for managing chaining/grouping of entities for services.

16. The system of claim 12, wherein the applications and services communicate through RESTful APIs to the aSDNC based on desired features/function.

17. The system of claim 12, wherein the aSDNC uses XML or JSON for configuring the vNEs.

18. The system of claim 12, wherein the aSDNC uses comma separated value (CSV) for managing the vNEs.

19. The system of claim 12, wherein the aSDNC uses formatted information in metadata for managing the vNEs.

20. The system of claim 12, wherein the aSDNC uses OpenFlow or ForCES for controlling the underlying physical and virtual entities.
